(19) United States
(12) Patent Application Publication
(10) Pub. No.: US 2005/0158430 A1
(43) Pub. Date: Jul. 21, 2005

(54) Food treatment system and method

(76) Inventors: Richard Mark Wiesman, Wayland, MA (US); Dick Taylor Atkinson, Hollis, NH (US); Andrew Cecil Harvey, Waltham, MA (US)

Correspondence Address: Iandiorio & Teska, 260 Bear Hill Road, Waltham, MA, 02451-1018, US

(21) Appl. No.: 11/016,939

(22) Filed: Dec. 20, 2004

Related U.S. Application Data
(60) Provisional application No. 60/531,349, filed on Dec. 19, 2003.

(51) Int. Cl. C12H 1/06

(52) U.S. Cl. 426/237

(57) ABSTRACT

A food treatment system and method with a pressurization zone, a dwell zone, and a depressurization zone. A linear pocket feeder includes a number of sealed chambers each housing a food product driven through the pressurization zone, the dwell zone, and the depressurization zone in sequence. The pressurization zone includes at least one purge region to prevent dilution of treatment fluid and also treatment fluid injection regions to pressurize the sealed chambers in a controlled fashion. The depressurization zone includes treatment fluid ejection regions to depressurize the sealed chambers and remove the treatment fluid therefrom in a controlled fashion. The treatment fluid injection regions are in fluid communication with the treatment fluid ejection regions to conserve treatment fluid and to minimize power required for pressurization.

### RELATED APPLICATIONS

This application claims priority to Provisional Patent Application Ser. No. 60/531,349 filed Dec. 19, 2003.

### FIELD OF THE INVENTION

This invention relates to a food treatment system and method useful for treating food products with a treatment fluid in a continuous process as opposed to a batch process.

### BACKGROUND OF THE INVENTION

It is known that certain gasses, such as carbon monoxide, injected into food products such as meat preserves the meat and keeps it appearing fresh for longer periods of time. Carbon monoxide and other treatment gases and liquids can retard spoilage, extend shelf life, decrease microbial activity, retard oxidation, and enhance color.

A viable and economical system for preserving meat using a treatment fluid in a continuous as opposed to a batch process has, to date, however, eluded the industry.

Some treatment fluids are expensive and/or toxic. Moreover, too rapid pressurization and/or depressurization can degrade certain food products. For example, nucleation and expansion of the dissolved treatment gas can disrupt meat tissue.

Various schemes have been developed to cook various food products in a continuous process using linear pocket feeders. See, for example, U.S. Pat. Nos. 3,908,034; 4,073,226; 1,495,450; 2,403,871; 4,636,395; 3,086,868; 3,071,065; 2,610,914; 2,556,385; 6,457,513; 3,662,676; and published U.S. Patent Application No. 2003/0113414A1 all incorporated herein by this reference.

Cooking food products, typically with steam, however, does not involve the same considerations as treating food products with an often toxic gas as stated above and thus these prior art patents are considered non-analogous art. And, note that those skilled in the art have failed to design a viable and economical system for treating meat or other food products in a continuous process despite the presence of this prior art. Thus, there is a long felt need for a continuous process food treatment system.

Linear pocket feeders have also been used in other industries, e.g., the coal industry. See, for example, U.S. Pat. Nos. 4,533,289; 4,410,429; and 4,502,827 also incorporated herein by this reference.

Still, the meat packaging industry, for one, has yet to devise a viable and economical system for preserving meat in a continuous process. It was even once attempted to inject carbon monoxide directly into an already packaged meat product and said attempt failed.

Another process, presently a batch process, for treating food products involves adding flavorings or colorings to meat food products such as smoke flavorings or teriyaki or spice flavorings. Typically, such flavorings are injected into each individual food product. In other cases, food product is loaded into a tumbler and then subjected to a vacuum before the flavoring is introduced. Again, the use of such a batch process is not always optimal as opposed to a continuous process.

### SUMMARY OF THE INVENTION

It is therefore an object of this invention to provide a system for and method of treating food products such as meat in a continuous process.

It is a further object of this invention to provide such a system and method which is economical to implement.

It is a further object of this invention to provide such a system and method which conserves the treatment fluid used and which also conserves energy and which limits the fluid transfer mechanisms required.

The invention results from the realization that a linear pocket feeder can be used to treat food products with a treatment fluid in an economical continuous process if, in one zone, each food product chamber is first purged to prevent dilution of the treatment fluid and the treatment fluid is injected into each chamber in a controlled way; if, in another downstream zone, the treatment fluid is removed from each chamber in a controlled fashion; and, if the treatment fluid is recycled from the second zone to be used again in the first zone.

The subject invention, however, in other embodiments, need not achieve all these objectives and the claims hereof should not be limited to structures or methods capable of achieving these objectives. In one example, the food product is first subjected to a treatment gas in a pressurization zone, sequentially pressurized, and, after a dwell period, the treatment gas is removed, recycled to the pressurization zone, and the food product is then sequentially depressurized. In another example, the food product is first subjected to a pressure less than atmospheric, a food treatment liquid is introduced, and, after a dwell period, the food treatment fluid is ejected and the food returned to atmospheric pressure.

This invention features a food treatment system useful for treating food products such as steak with a treatment fluid such as a gas (e.g., carbon monoxide). In one example, there is a pressurization zone, a dwell zone, and a depressurization zone. A linear pocket feeder includes a plurality of sealed chambers each housing a food product and driven through the pressurization zone, the dwell zone, and the depressurization zone in sequence. The pressurization zone includes at least one purge region to prevent dilution of treatment fluid and also a plurality of treatment fluid injection regions to pressurize the sealed chambers in a controlled fashion. The depressurization zone includes a plurality of treatment fluid ejection regions to depressurize the sealed chambers and remove the treatment fluid therefrom in a controlled fashion. Preferably, the treatment fluid injection regions are in fluid communication with the treatment fluid ejection regions to conserve treatment fluid.

It is beneficial in some embodiments to connect one region of the depressurization zone with the purge region of the pressurization zone. In one example, the dwell zone includes a pressure vessel for prolonging the treatment time of the food product.

This invention also features a food treatment method where a food product is subjected to a pressurization zone, a dwell zone, and a depressurization zone. In the pressurization zone, the food product is subjected to at least one purge region to prevent dilution of treatment fluid. The food product is then subjected to a plurality of treatment fluid injection regions to pressurize the food product in the controlled fashion. In the depressurization zone, the food product is subjected to a plurality of treatment fluid ejection regions to depressurize the food product in a controlled fashion. The treatment fluid injection regions of the pressurization zone are preferably connected to the treatment fluid ejection regions of the depressurization zone to conserve treatment fluid. In one example, the pressurization zone, the dwell zone, and the depressurization zone are disposed in series. In another example, two series of pressurization, dwell, and depressurization zones are in parallel.

One preferred treatment fluid is carbon monoxide. In another example, the purge region of the pressurization zone is connected to a region in the depressurization zone. Also, the food product may be delivered to a pressure vessel in the dwell zone to prolong the treatment of the food before it is returned to the linear pocket feeder for depressurization.

One food treatment system in accordance with this invention features a pressurization zone, a dwell zone, and a depressurization zone. A linear pocket feeder includes a plurality of sealed chambers each housing a food product driven through the pressurization zone, the dwell zone, and the depressurization zone in sequence. Typically, the pressurization zone includes at least one purge region to prevent dilution of treatment fluid and also a plurality of treatment fluid injection regions to pressurize each sealed chamber in a controlled step-wise fashion from a pressure P₁ to a pressure P₄. The depressurization zone includes a plurality of treatment fluid ejection regions to depressurize the sealed chambers and remove the treatment fluid therefrom in a controlled step-wise fashion from the pressure P₄ to the pressure P₁. Preferably, the treatment fluid injection regions are in fluid communication with the treatment fluid ejection regions to conserve treatment fluid. For example, the treatment fluid ejection region at pressure P₄ is connected to the treatment fluid injection region at pressure P₄, and the treatment fluid ejection region at pressure P₁ is connected to treatment fluid injection region at pressure P₁.

Another food treatment system comprises a depressurization zone, a dwell zone, and a pressurization zone. A linear pocket feeder includes a plurality of sealed chambers each housing a food product driven through the depressurization zone, the dwell zone, and the pressurization zone in sequence. The depressurization zone includes at least one purge region to prevent dilution of treatment fluid and at least one treatment fluid injection region, the pressurization zone includes at least one treatment fluid ejection region to pressurize the sealed chambers and remove the treatment fluid therefrom in a controlled fashion. The treatment fluid injection regions are preferably in fluid communication with the treatment fluid ejection regions to conserve treatment fluid.

In one example, the pressurization zone, the dwell zone, and the depressurization zone are in series. In another example, there are two series of pressurization, dwell, and depressurization zones in parallel. The treatment fluid may be a fluid flavoring composition for meat food products. In one embodiment, the dwell zone includes a pressure vessel for prolonging the treatment time of the food product.

One food treatment method in accordance with the subject invention includes subjecting a food product to a depressurization zone, a dwell zone, and a pressurization zone, in the depressurization zone, subjecting the food product to a purge to prevent dilution of treatment fluid and subjecting the food product to at least one treatment fluid injection, in the pressurization zone, subjecting the food product to at least one treatment fluid ejection to pressurize the food product, and recycling the treatment fluid from the pressurization zone to the depressurization zone to conserve treatment fluid. One food treatment system in accordance with the subject invention features a depressurization zone, a dwell zone, and a pressurization zone, a linear pocket feeder including a plurality of sealed chambers each housing a food product driven through the depressurization zone, the dwell zone, and the pressurization zone in sequence, the depressurization zone including a plurality of treatment fluid injection regions to depressurize each sealed chamber in a controlled step-wise fashion to a pressure less than atmospheric, the pressurization zone including a plurality of treatment fluid ejection regions to pressurize the sealed chambers and remove the treatment fluid therefrom in a controlled step-wise fashion from the pressure less than atmospheric to a pressure greater than or equal to atmospheric, and the treatment fluid injection regions in fluid communication with the treatment fluid ejection regions to conserve treatment fluid.

### BRIEF DESCRIPTION OF THE DRAWINGS

Other objects, features and advantages will occur to those skilled in the art from the following description of a preferred embodiment and the accompanying drawings, in which:

FIG. 1 is a schematic cross-sectional view of one embodiment of a pressurization zone for a food treatment system in accordance with the subject invention;

FIG. 2 is a schematic cross-sectional view of one embodiment of a depressurization zone for a food treatment system in accordance with the subject invention;

FIG. 3 is a schematic conceptual view of one embodiment of a complete food treatment system in accordance with the subject invention wherein two series of pressurization and depressurization zones are arranged in parallel; and

FIG. 4 is a schematic conceptual view of one embodiment of a food treatment system in accordance with the subject invention wherein the pressurization zone, the dwell zone, and the depressurization zones are all in a single series and also showing the addition of a pressure vessel having its own separate product transport means in the dwell zone for prolonging the treatment of the food product.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

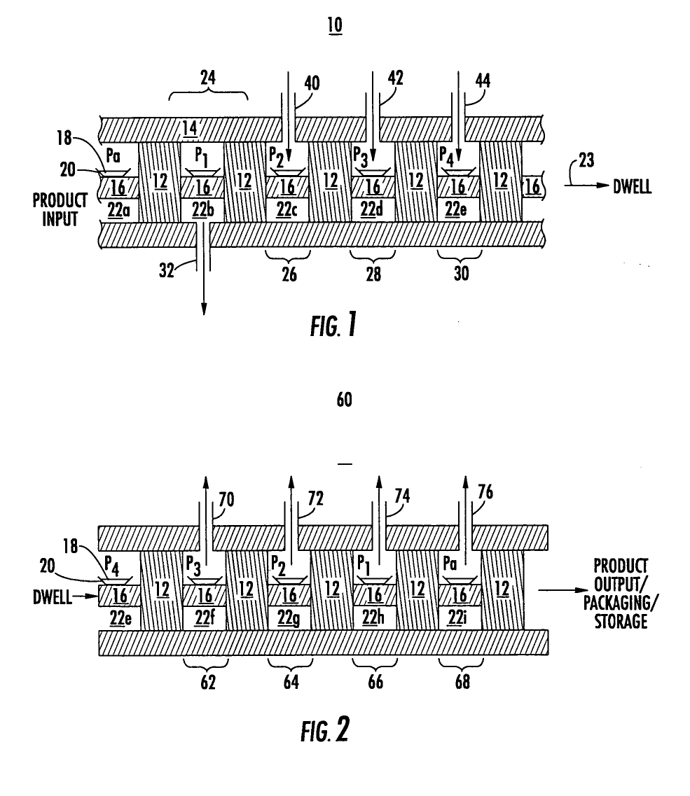

FIG. 1 shows an example of pressurization zone 10 for a food treatment system in accordance with the subject invention. A linear pocket feeder includes a plurality of sealed chambers 22 defined by pistons 12 sealed with respect to chamber (e.g., cylinder) wall 14. The pistons are each typically connected by links 16. Food product 18 such as steaks on trays 20 may reside on links 16 as they travel through the treatment system in accordance with this invention or the food products may otherwise be carried in chambers 22a-e defined by adjacent pistons. It is understood that in FIG. 1 chamber 22b previously occupied the position of chamber 22a, chamber 22c previously occupied the position of chamber 22b in the figure, and the like as the linear pocket feeder is driven in the direction of vector 23.

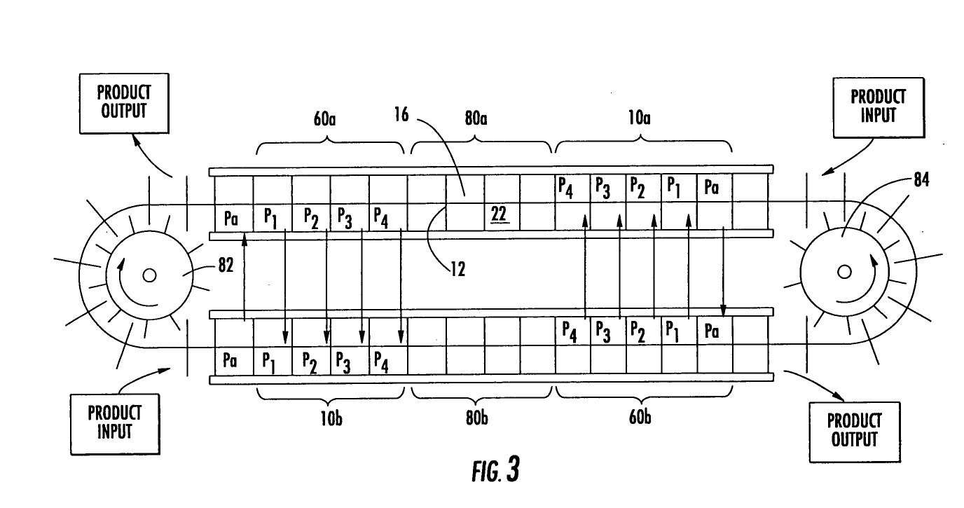

Pressurization zone 10 of the system and method of this invention includes purge region 24 where typically atmospheric air is purged from chamber 22b as shown via port 32. Thus, the meat product in chamber 22b is subject to pressure P₁ which is typically less than atmospheric pressure or some other nominal pressure in chamber 22a. Chamber 22b may be repeated as desired. For example, fluid in chamber 22b could be discharged to chamber 22i in depressurization zone 60, FIG. 2, and connected to a vacuum pump. The valving, pumping, and condensing mechanisms used in accordance with pressurization zone 10 are not depicted in FIG. 1 for the sake of clarity.

One reason to purge chamber 22a at purge region 24 is to prevent dilution of the treatment fluid introduced into the food product at treatment fluid injection regions 26, 28, and 30. For example, chamber 22c is shown located at treatment injection region 26 where, in one example, carbon monoxide is introduced at pressure P₂ via port 40. Similarly, a treatment fluid at pressure P₃ is introduced via port 42 into chamber 22d at treatment injection region 28 and a treatment fluid at pressure P₄ is introduced into chamber 22e via port 44. In another example, the treatment fluid is a liquid food flavoring composition and pressure P₁ is less than atmospheric and pressures P₂-P₄ are less than atmospheric.

For the carbon monoxide treatment example, each chamber containing a meat product 18 in a sealed fashion is first at atmospheric or some other nominal pressure Pₐ, then subjected to purging at pressure P₁ in purge region 24, next subjected to treatment fluid at pressure P₂ at injection region 26, subjected to treatment fluid at pressure P₃ at injection region 28, and then subjected to treatment fluid at pressure P₄ at injection region 30. In this way, the treatment fluid injected at injection regions 26, 28, and 30 is not diluted by any fluid in chambers 22 and, in addition, the food product is pressurized in a sequential step-wise fashion. There may be additional purge regions and more or less injection regions than the three shown in FIG. 1. In addition, it is not a necessary limitation of this invention that a purge or injection region corresponds to the volume of a single chamber 22.

In one specific example, Pₐ was atmospheric, P₁ was less than 0.1 psi, P₂ was 333 psi, P₃ was 666 psi, and P₄ was 1000 psi. In general,
Pₐ>P₁ and (1)
P₁<P₂≦P₃ (2)

In the example where the treatment fluid is a fluid food flavoring composition, P₁-P₄ are all less than atmospheric and thus chambers 22b-22e are depressurized to a negative or vacuum pressure.

For the example where the treatment fluid is carbon monoxide, after a sufficient dwell time in a dwell zone, the chamber 22e at pressure P₄ arrives at depressurization zone 60, FIG. 2 where a time gradient pressure reduction occurs before product packaging, storage, or further processing. In this example, depressurization zone 60 includes treatment fluid ejection regions 62, 64, and 66. Port 70 reduces the pressure in chamber 22f to P₃ while bleeding off some of the treatment fluid in chamber 22f in region 62. Similarly, port 72 reduces the pressure in chamber 22g to P₂ while bleeding off treatment fluid in chamber 22g in region 64; and port 74 further reduces the pressure in chamber 22h to P₁ while bleeding off any remaining treatment fluid in chamber 22h in region 66. Port 76 in zone 68 may be incorporated to introduce air from chamber 22b into chamber 22i which has previously been depressurized and all the treatment fluid therein removed. After 22i, an additional chamber may be used to introduce atmospheric air. Again, there may be more or less treatment fluid ejection regions than the three shown in FIG. 2. And, each such region may depressurize more than one chamber at a time.

In the example where the treatment fluid is a flavoring composition, zone 60 sequentially repressurizes each chamber from a vacuum state back to atmospheric pressure.

In one preferred embodiment, port 70, FIG. 2 is connected to port 44, FIG. 1 via suitable conduits and pumping, valving, and condensing mechanisms as known in the art. Similarly, port 72, FIG. 2 may be connected to port 42, FIG. 1 and port 74, FIG. 2 is connected to port 40, FIG. 1 to conserve treatment fluid, to prevent its escape into the atmosphere, and to minimize compressor and pumping power requirements. Indeed, port 76, FIG. 2 can be connected to port 32, FIG. 1 resulting in a truly closed system.

In the case where the fluid treatment is a liquid flavoring composition, the system can also be set up to operate in reverse, that is zone 60, FIG. 2 is used to sequentially lower the pressure in each chamber 22h, 22g, 22f to subatmospheric pressures (e.g., a vacuum) and to introduce the flavoring composition to the food product held at less than atmospheric pressure. At zone 10, FIG. 1, the flavoring composition is removed from chambers 22e, 22d, 22c, and each chamber is sequentially raised back to atmospheric pressure.

In cases where temperature control is a requirement, the treatment fluid injected via ports 40, 42, and 44 could be temperature regulated as known by those skilled in the art. So, for example, steam or a liquid flavoring composition could be injected at temperature T₁ at port 40, at temperature T₂ at port 42, and at temperature T₃ at port 44. Also, the treatment fluids injected at ports 40, 42, and 44 could all be different. And, by “treatment fluid” as used herein we mean any flowable substance including but not limited to various powders and the like.

One embodiment is schematically shown in FIG. 3 where dual pressurization zones 10a and 10b and dual decompression zones 60a and 60b are disposed in parallel on opposite sides of the linear pocket feeder loop. The dwell zones are shown at 80a and 80b where the food product in each chamber is subjected to the treatment fluid for a period of time governed by the drive rate of pocket feeder drive mechanisms 82 and 84 and the size of the system. Note the ease of connecting the fluid ejection regions in zones 60a and 60b to the fluid injection regions in zones 10a and 10b, respectively.

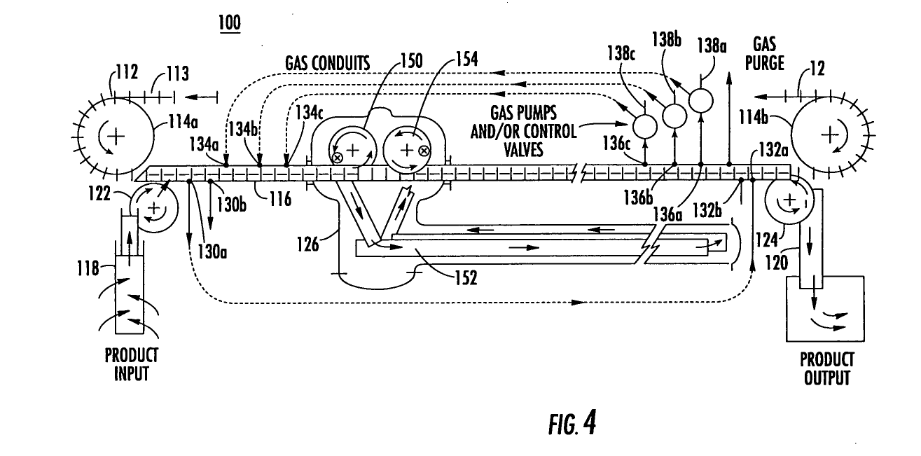

In other embodiments, the pressurization, dwell, and decompression zones may all be in a single series as exemplified in FIG. 4. Linear pocket feeder 100 includes a series of pistons 112 that are joined together by links 113 in a string such that they can be driven by drive means such as sprockets 114a and 114b. The string of pistons 112 run through lengthy pressure vessel 116. Pressure vessel 116 includes loading station 118 for inputting a food product (e.g., meat products) and also includes off-loading station 120 for outputting the food product. Product transfer mechanism 122 transfers the food product from loading station 118 to pressure vessel 116. Product transfer mechanism 124 transfers the food product from pressure vessel 116 to output station 120.

Ports 130a and 130b in the pressurization zone purge air or fluid from between the pistons after a food product has entered pressure vessel 116. Port 132a in the depressurization zone input air or fluid to pressure vessel 116 before the food product is transferred to off-loading station 120. Ports 134a-c inject pressurized fluid into pressure vessel 116. In this way, the food product carried between any two adjacent pistons 112 is subject to a treatment fluid which can retard spoilage, decrease microbial activity, and the like. Ports 136a-c bleed pressurized fluid from pressure vessel 116 at the depressurization zone of the system as discussed above.

In accordance with the invention, to minimize the loss or dilution of treatment fluid, pumps and/or control valves 138a-c are used to bleed fluid from ports 136a-c and input the bled fluid into input ports 134a-c, respectively. It is preferable to have fluid bled from port 136a to be input to port 134a since it will be the least pressurized fluid compared to the fluid bled from port 136b and input to port 134b and the fluid bled from port 136c and input to port 134c. Compressors (not shown) can be used to evacuate ambient fluid from between the pistons both near the input 130b, and to evacuate treatment fluid between the pistons near the discharge 132b, and may be used to recompress treatment fluid for return to the pressurization zone.

Pressure vessel 126 may be optionally used to extend the dwell time a food product is subjected to fluid treatment. Transfer mechanism 150 removes a food product from between adjacent pistons 112 and delivers it to conveyance mechanism 152. Transfer mechanism 154 delivers a food product after prolonged treatment in pressure vessel 126 to a vacant food pocket between adjacent pistons in the linear pocket feeder in pressure conduit 116. In this way, the dwell time a food product is subjected to a treatment fluid at an evaluated pressure can be extended and/or the rate of food treatment can be matched to the rate of processing stations and equipment upstream and downstream of the treatment system of this invention.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

1. A food treatment system comprising:
a pressurization zone, a dwell zone, and a depressurization zone;
a linear pocket feeder including a plurality of sealed chambers each housing a food product driven through the pressurization zone, the dwell zone, and the depressurization zone in sequence;
the pressurization zone including at least one purge region to prevent dilution of treatment fluid and a plurality of treatment fluid injection regions to pressurize the sealed chambers in a controlled fashion;
the depressurization zone including a plurality of treatment fluid ejection regions to depressurize the sealed chambers and remove the treatment fluid therefrom in a controlled fashion; and
the treatment fluid injection regions in fluid communication with the treatment fluid ejection regions to conserve treatment fluid.

2. The system of claim 1 in which the pressurization zone, the dwell zone, and the depressurization zone are in series in one direction between spaced drive means for driving the linear pocket feeder.

3. The system of claim 1 in which there are two series of pressurization, dwell, and depressurization zones in parallel.

4. The system of claim 1 in which the treatment fluid is carbon monoxide.

5. The system of claim 1 in which the depressurization zone includes at least one region in fluid communication with the purge region of the pressurization zone.

6. The system of claim 1 in which the dwell zone includes a pressure vessel in communication with the linear pocket feeder for prolonging the treatment time of the food product.

7. The system of claim 1 in which the food product is meat.

8. The system of claim 7 in which the meat is beef.

9. A food treatment method comprising:
subjecting a food product to a pressurization zone, a dwell zone, and a depressurization zone;
in the pressurization zone, subjecting the food product to a purge to prevent dilution of treatment fluid and subjecting the food product to a plurality of treatment fluid injections to pressurize the food product in a controlled fashion;
in the depressurization zone, subjecting the food product to a plurality of treatment fluid ejections to depressurize the food product in a controlled fashion; and
recycling the treatment fluid from the depressurization zone to the pressurization zone to conserve treatment fluid.

10. The method of claim 9 in which the pressurization zone, the dwell zone, and the depressurization zone are disposed in series in one direction between drive means.

11. The method of claim 9 in which there are two series of pressurization, dwell, and depressurization zones in parallel.

12. The method of claim 9 in which the treatment fluid is carbon monoxide.

13. The method of claim 9 in which a purge region of the pressurization zone is connected to a region in the depressurization zone.

14. The method of claim 9 further including the step of transferring the food product to and from a pressure vessel in communication with the linear pocket feeder in the dwell zone to prolong the treatment of the food.

15. The method of claim 9 in which the food product is meat.

16. The method of claim IS in which the meat is beef.

17. A food treatment system comprising:
a pressurization zone, a dwell zone, and a depressurization zone;
a linear pocket feeder including a plurality of sealed chambers each housing a food product driven through the pressurization zone, the dwell zone, and the depressurization zone in sequence;
the pressurization zone including at least one purge region to prevent dilution of treatment fluid and a plurality of treatment fluid injection regions to pressurize each sealed chamber in a controlled step-wise fashion from a pressure P₁ to a pressure P₄;
the depressurization zone including a plurality of treatment fluid ejection regions to depressurize the sealed chambers and remove the treatment fluid therefrom in a controlled step-wise fashion from the pressure P₄ to the pressure P₁; and
the treatment fluid injection regions in fluid communication with the treatment fluid ejection regions to conserve treatment fluid, the treatment fluid ejection region at pressure P₄ connected to the treatment fluid injection region at pressure P₄, the treatment fluid ejection region at pressure P₁ connected to treatment fluid injection region at pressure P₁.

18. A food treatment system comprising:
a pressurization zone, a dwell zone, and a depressurization zone;
a feeder including a plurality of sealed chambers each housing a food product driven through the pressurization zone, the dwell zone, and the depressurization zone in sequence;
the pressurization zone including at least one purge region to prevent dilution of treatment fluid and a plurality of treatment fluid injection regions to pressurize the sealed chambers in a controlled fashion; and
the depressurization zone including a plurality of treatment fluid ejection regions to depressurize the sealed chambers and remove the treatment fluid therefrom in a controlled fashion.

19. A food treatment system comprising:
a depressurization zone, a dwell zone, and a pressurization zone;
a linear pocket feeder including a plurality of sealed chambers each housing a food product driven through the depressurization zone, the dwell zone, and the pressurization zone in sequence;
the depressurization zone including at least one purge region to prevent dilution of treatment fluid and at least one treatment fluid injection region;
the pressurization zone including at least one treatment fluid ejection region to pressurize the sealed chambers and remove the treatment fluid therefrom in a controlled fashion; and
the treatment fluid injection regions in fluid communication with the treatment fluid ejection regions to conserve treatment fluid.

20. The system of claim 19 in which the pressurization zone, the dwell zone, and the depressurization zone are in series.

21. The system of claim 19 in which there are two series of pressurization, dwell, and depressurization zones in parallel.

22. The system of claim 19 in which the treatment fluid is a fluid flavoring composition.

23. The system of claim 19 in which the dwell zone includes a pressure vessel for prolonging the treatment time of the food product.

24. The system of claim 19 in which the food product is meat.

25. A food treatment method comprising:
subjecting a food product to a depressurization zone, a dwell zone, and a pressurization zone;
in the depressurization zone, subjecting the food product to a purge to prevent dilution of treatment fluid and subjecting the food product to at least one treatment fluid injection;
in the pressurization zone, subjecting the food product to at least one treatment fluid ejection to pressurize the food product; and
recycling the treatment fluid from the pressurization zone to the depressurization zone to conserve treatment fluid.

26. The method of claim 25 in which the depressurization zone, the dwell zone, and the pressurization zone are disposed in series.

27. The method of claim 25 in which there are two series of pressurization, dwell, and depressurization zones in parallel.

28. The method of claim 25 in which the treatment fluid is a food flavoring composition.

29. A food treatment system comprising:
a depressurization zone, a dwell zone, and a pressurization zone;
a linear pocket feeder including a plurality of sealed chambers each housing a food product driven through the depressurization zone, the dwell zone, and the pressurization zone in sequence;
the depressurization zone including a plurality of treatment fluid injection regions to depressurize each sealed chamber in a controlled step-wise fashion to a pressure less than atmospheric;
the pressurization zone including a plurality of treatment fluid ejection regions to pressurize the sealed chambers and remove the treatment fluid therefrom in a controlled step-wise fashion from a pressure less than atmospheric to a pressure greater than or equal to atmospheric; and
the treatment fluid injection regions in fluid communication with the treatment fluid ejection regions to conserve treatment fluid.

30. A food treatment system comprising:
a depressurization zone, a dwell zone, and a pressurization zone;
a feeder including a plurality of sealed chambers each housing a food product driven through the depressurization zone, the dwell zone, and the pressurization zone in sequence;
the depressurization zone including at least one purge region to prevent dilution of treatment fluid and a plurality of treatment fluid injection regions to depressurize the sealed chambers in a controlled fashion; and
the pressurization zone including a plurality of treatment fluid ejection regions to pressurize the sealed chambers and remove the treatment fluid therefrom in a controlled fashion.
